(19) United States
(12) Patent Application Publication
(10) Pub. No.: US 2026/0099161 A1
(43) Pub. Date: Apr. 9, 2026

(54) Integrated, series-connected and electrically-controlled gas valve

(71) Applicant: Qi’an Chen, Rui'an (CN)

(72) Inventor: Qi’an Chen, Rui'an (CN)

(21) Appl. No.: 19/415,913

(22) Filed: Dec. 11, 2025

(30) Foreign Application Priority Data
Sep. 16, 2025 (CN) 202521992638.8

(51) Int. Cl. G05D 7/06; F16K 1/36; F16K 1/42; F16K 1/46; F16K 27/02

(52) U.S. Cl. CPC G05D 7/0647; F16K 1/36; F16K 1/42; F16K 1/46; F16K 27/029

(57) ABSTRACT

An integrated, series-connected and electrically-controlled gas valve is provided, including a valve body. A gas inlet runner, a gas outlet runner, a first cavity, and a second cavity. The first cavity and the second cavity are adjacent to each other. A first valve seat and a first sealing gasket are arranged in the first cavity. A second valve seat and a second sealing gasket are arranged in the second cavity. The valve body is provided with a first electromagnetic valve at a position corresponding to the first cavity and a second electromagnetic valve at a position corresponding to the second cavity. The first electromagnetic valve is provided with a first piston rod connected to the first sealing gasket. The second electromagnetic valve is provided with a second piston rod connected to the second sealing gasket. A rubber ring is arranged at another end portion of the second piston rod.

### TECHNICAL FIELD

The present disclosure relates to the technical field of engine gas control devices, and in particular, to an integrated, series-connected and electrically-controlled gas valve.

### BACKGROUND

A gas engine is a type of power machinery that operates by using gas as a fuel. It typically has a gas supply pipeline, and a gas valve needs to be mounted on the pipeline to open or close the pipeline.

The existing gas valve includes a first electromagnetic valve and a second electromagnetic valve which are arranged separately. The first electromagnetic valve and the second electromagnetic valve are connected through a pipeline. However, in this type of gas valve, it is inaccurate to control a flow rate because of a long distance between the two electromagnetic valves. Furthermore, piston rods on the electromagnetic valves are made of metal. Consequently, when the piston rods attract each other, an excessively high attraction force may cause the piston rods to possibly vibrate or move unsteadily. As a result, inaccurate control is caused, and noises are easily generated.

### SUMMARY

Objectives of the present disclosure: In order to overcome the shortcomings in the existing art, the present disclosure provides an integrated, series-connected and electrically-controlled gas valve. Two electromagnetic valves are adjacent to each other, so that no pipeline needs to be arranged. During gas conveying, a pressure is more stable. At a rated flow rate, a gas pressure drop is smaller, and it is accurate to control a flow rate. In addition, a rubber ring is arranged on an upper end surface of a piston rod to reduce an attraction force, so that the piston rods are steady, accurate control is achieved, and no noise is generated.

Technical solutions of the present disclosure are as follows: An integrated, series-connected and electrically-controlled gas valve includes a valve body. A gas inlet runner, a gas outlet runner, and a first cavity and a second cavity which are arranged between the gas inlet runner and the gas outlet runner are arranged on the valve body. The first cavity and the second cavity are adjacent to each other. A first valve seat and a first sealing gasket cooperating with the first valve seat are arranged in the first cavity. A second valve seat and a second sealing gasket cooperating with the second valve seat are arranged in the second cavity. The valve body is provided with a first electromagnetic valve at a position corresponding to the first cavity and a second electromagnetic valve at a position corresponding to the second cavity. The first electromagnetic valve is provided with a first piston rod connected to the first sealing gasket. The first sealing gasket opens or closes the first valve seat under action of the first piston rod. The first piston rod is sleeved with a first reset spring, and the first reset spring resists against the first sealing gasket, to drive the first sealing gasket to move towards the first valve seat. The second electromagnetic valve is provided with a second piston rod connected to the second sealing gasket. The second sealing gasket opens or closes the second valve seat under action of the second piston rod. The second piston rod is provided with a second reset spring for driving the second piston rod to move towards the second valve seat. A rubber ring is arranged at another end portion of the second piston.

By using the foregoing technical solution, both the first electromagnetic valve and the second electromagnetic valve are arranged on the valve body and are adjacent to each other, thereby shortening a distance between the two electromagnetic valves. This ensures a stable pressure during gas conveying and accurate flow rate control. Meanwhile, the rubber ring is arranged at the upper end portion of the second piston rod, so that an attraction force of the second piston rod can be reduced when the second piston rod attracts and opens the second valve seat, to prevent direct impact between the second piston rod and a metal part on the second electromagnetic valve, thus implementing more precise control. The second piston rod moves more steadily, and noises are reduced.

In a further setting of the present disclosure, a mounting cavity with an opened bottom is arranged at a lower end portion of the second piston rod. An annular boss is arranged inside the mounting cavity. The second sealing gasket is located inside the mounting cavity and resists against the annular boss. When the second sealing gasket resists against the second valve seat, the second valve seat is closed, and an end portion of the second valve seat is located inside the mounting cavity.

By using the above further setting, the second sealing gasket has a firm structure and can be in better sealing fit with the second valve seat, so that the sealing performance is good when the second valve seat is closed.

In a still further setting of the present disclosure, an accommodating cavity is arranged at an upper end portion of the second piston rod. The second reset spring is arranged inside the accommodating cavity. The rubber ring is integrally formed on the upper end surface of the second piston rod and is located on an outer ring of the accommodating cavity.

By using the above further setting, the second reset spring has a stable structure, so that it better drives the second piston rod to move towards the second valve seat.

In a still further setting of the present disclosure, the valve body is provided with a passage communicated with the first cavity, and a pressure sensor is arranged at the passage.

By using the above further settings, a pressure on the gas valve can be monitored in real time, and a flow rate can be calculated, to ensure that an engine can operate in an efficient, economical, and environmentally-friendly manner under various driving conditions.

In a still further setting of the present disclosure, a sealing rib and inclined surfaces located on two sides of the sealing rib are arranged at an upper end of the first valve seat. A pressure plate that moves synchronously with the first sealing gasket is arranged on an upper end surface of the first sealing gasket. The first reset spring resists against the pressure plate. The first sealing gasket is in contact fit with the sealing rib to close the first valve seat. The first sealing gasket is separated from the sealing rib to open the first valve seat.

By using the above further setting, after power loss, the first reset spring pushes the first sealing gasket to move downwards to close the first valve seat, with high safety redundancy. The cooperation between the sealing rib and the sealing gasket implements good sealing performance, and there are no air holes in the sealing rib and the two inclined surfaces, which will not affect the sealing performance and can avoid a failure of opening the sealing gasket because of tar residues in gas. The pressure plate presses the sealing gasket to ensure good sealing between the sealing gasket and the sealing rib and avoid gas leakage from a gap reserved between the sealing gasket and the sealing rib.

In a still further setting of the present disclosure, an inverted “T”-shaped connection rod is arranged at an end portion of the first piston rod. A sunken cavity is formed in the first sealing gasket. An annular elastic sheet is arranged on an inner side wall of the sunken cavity in a circumferential direction of the inner side wall. The elastic sheet and a bottom of the sunken cavity are spaced apart to form a connection slot. A transverse portion of the connection rod is located inside the connection slot, and the elastic sheet presses the transverse portion. A lower end surface of the transverse portion of the connection rod is inclined. A first through hole cooperating with a vertical portion of the connection rod is formed in a middle position of the elastic sheet. The vertical portion of the connection rod is located inside the first through hole.

By using the above further setting, it is convenient for connection between the first piston rod and the first sealing gasket. The transverse portion is inserted from the first through hole, and the elastic sheet can deform, so that the transverse portion enters the connection slot. The elastic sheet presses the transverse portion to lock the transverse portion and prevent it from being detached. The arrangement of the inclined surfaces facilitates sliding of the transverse portion and is easy for mounting.

In a still further setting of the present disclosure, a positioning boss is arranged at a middle position of the first sealing gasket. A second through hole and a positioning flange that is located at a periphery of the second through hole and extends upwards are arranged at a middle position of the pressure plate. The positioning boos is located inside the second through hole. An upper end surface of the positioning flange is lower than an upper end surface of the positioning boss.

By using the above further setting, the pressure plate does not fully wrap around the first sealing gasket, making it easy to connect the first sealing gasket to the first piston rod, but not affecting the effect of the pressure plate on the first sealing gasket.

In a still further setting of the present disclosure, the integrated, series-connected and electrically-controlled gas valve further includes a silencer piece, and the silencer piece is arranged at an upper end portion of the first piston rod.

By using the above further setting, noises are reduced, so that when the first piston rod moves upwards to be opened under the action of the first electromagnetic valve, collision with the first piston rod can be buffered, and a silencing effect can be achieved.

### BRIEF DESCRIPTION OF THE DRAWINGS

FIG. 1 is a schematic structural diagram of a specific embodiment of the present disclosure;

FIG. 2 is a schematic diagram of a position of a pressure sensor of a specific embodiment of the present disclosure;

FIG. 3 is a cross-sectional view of a specific embodiment of the present disclosure;

FIG. 4 is a schematic diagram of a valve body of a specific embodiment of the present disclosure;

FIG. 5 is an enlarged view of part A in FIG. 4;

FIG. 6 is a cross-sectional view of a pressure sensor and a first electromagnetic valve of a specific embodiment of the present disclosure;

FIG. 7 is a schematic diagram of a second electromagnetic valve of a specific embodiment of the present disclosure;

FIG. 8 is a schematic diagram of a second piston rod of a specific embodiment of the present disclosure;

FIG. 9 is a cross-sectional view of a second electromagnetic valve of a specific embodiment of the present disclosure;

FIG. 10 is a schematic diagram of a first electromagnetic valve of a specific embodiment of the present disclosure;

FIG. 11 is a schematic diagram of a first piston rod and a first sealing gasket of a specific embodiment of the present disclosure;

FIG. 12 is a schematic diagram of a first reset spring and a first piston rod of a specific embodiment of the present disclosure;

FIG. 13 is a cross-sectional view of a first sealing gasket of a specific embodiment of the present disclosure;

FIG. 14 is a schematic diagram of a first piston rod of a specific embodiment of the present disclosure; and

FIG. 15 is a cross-sectional view of a first piston rod and a first sealing gasket of a specific embodiment of the present disclosure.

In the accompanying drawings: 1: valve body; 11: passage; 2: first cavity; 21: first valve seat; 211: sealing rib; 212: inclined surface; 22: first sealing gasket; 221: sunken cavity; 222: elastic sheet; 223: connection slot; 224: positioning boss; 23: pressure plate; 232: positioning flange; 3: second cavity; 31: second valve seat; 32: second sealing gasket; 4: first electromagnetic valve; 41: first piston rod; 411: connection rod; 42: first reset spring; 5: second electromagnetic valve; 51: second piston rod; 511: rubber ring; 512: mounting cavity; 513: annular boss; 514: accommodating cavity; 52: second reset spring; 6: pressure sensor; and 7: silencer piece.

### DETAILED DESCRIPTION OF THE EMBODIMENTS

The following clearly and completely describes the technical solutions in the embodiments of the present disclosure with reference to the accompanying drawings. Apparently, the described embodiments are some of the embodiments of the present disclosure rather than all the embodiments. All other embodiments obtained by a person of ordinary skill in the art based on the embodiments of the present disclosure without making creative efforts shall fall within the protection scope of the present disclosure.

It should be noted that all directional indications (such as up, down, front, back, . . . ) involved in the description of the present disclosure are only used to explain relative positional relationships, motion states, and the like between various components in specific postures (as shown in the accompanying drawings). If the specific postures change, the directional indications also change correspondingly.

In addition, the descriptions of the terms such as “first” and “second” in the present disclosure are used for descriptive purposes only and are not to be construed as indicating or implying relative importance or to implicitly indicate the number of technical features indicated. In the description of the present disclosure, unless explicitly specified, “plurality” means at least two, for example, two or three.

In addition, the technical solutions between the embodiments of the present disclosure can be combined with each other, but need to be implemented by those skilled in the art. When there is a conflict in a combination of technical solutions or the combination cannot be achieved, it should be considered that the combination of the technical solutions does not exist and does not fall within the protection scope of the present disclosure.

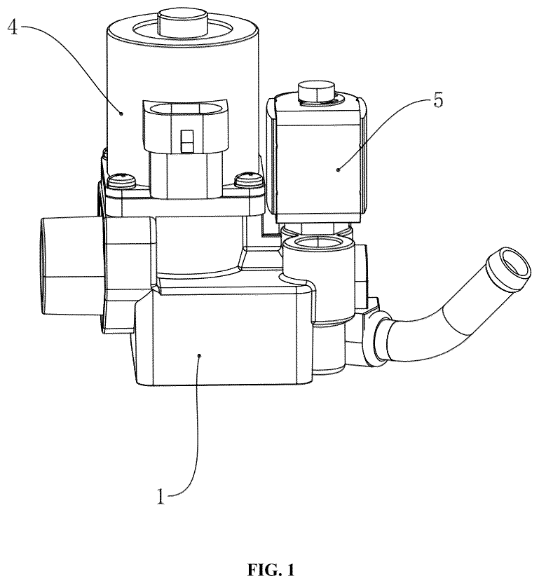

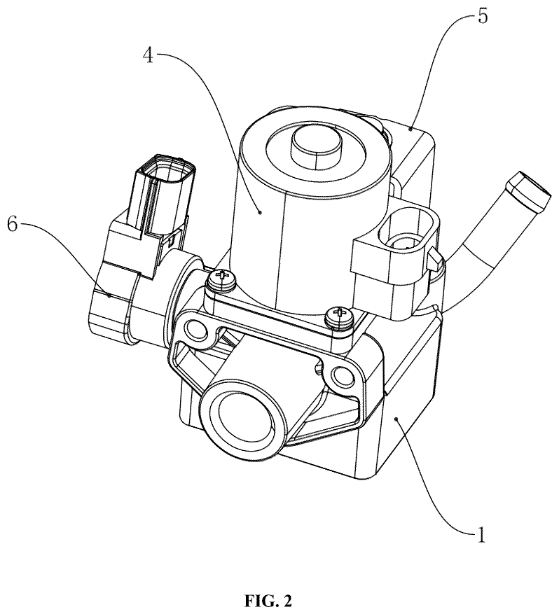

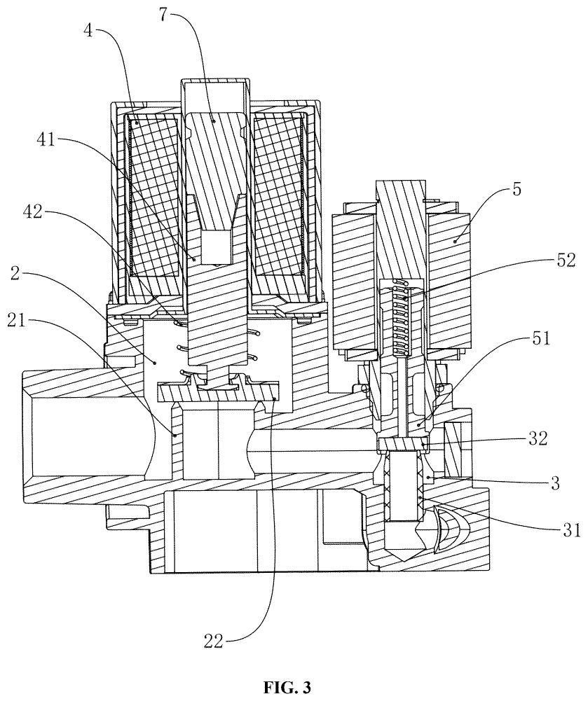

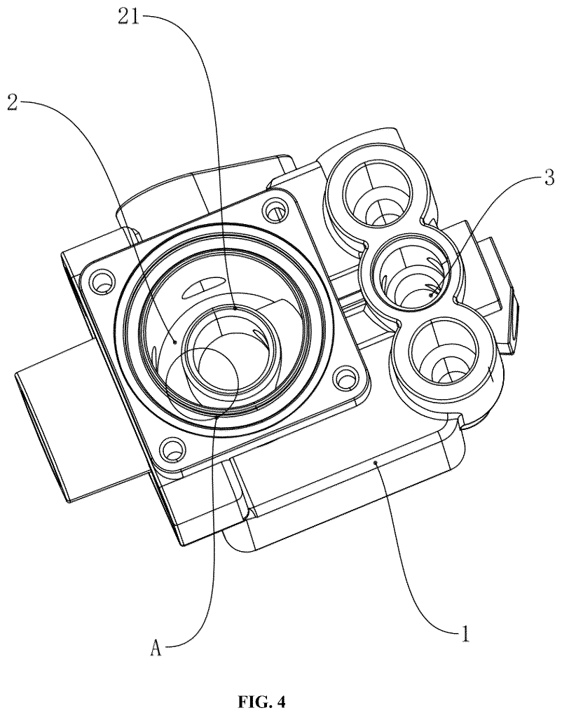

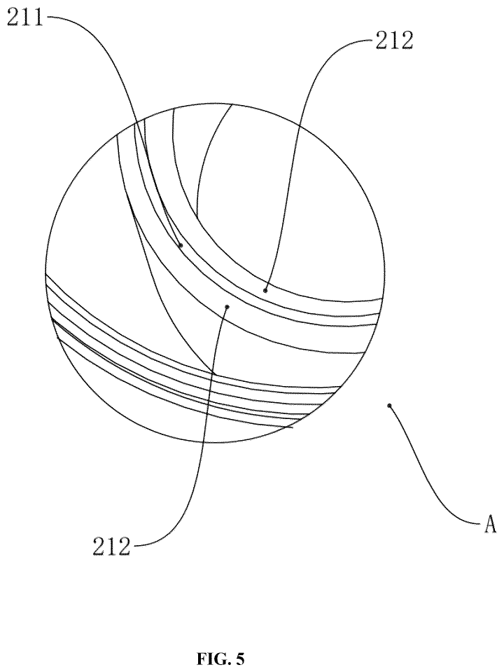

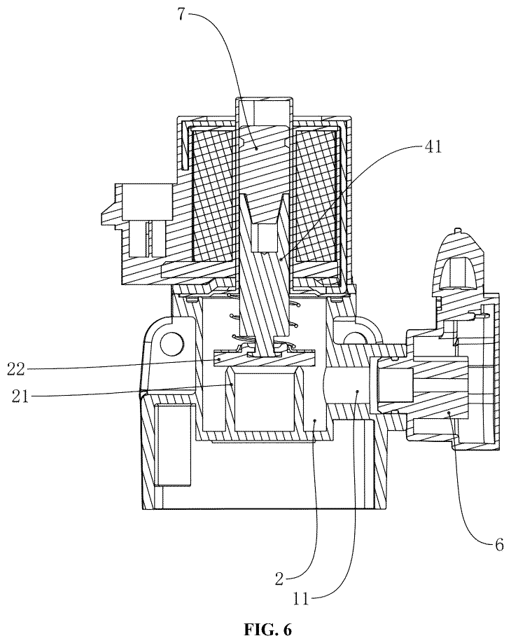

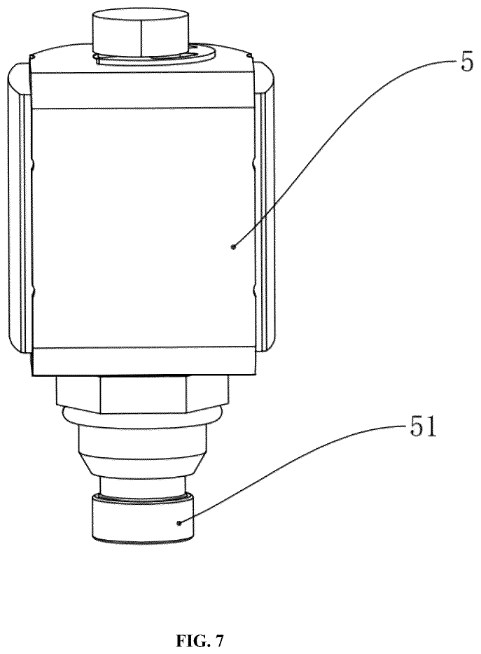

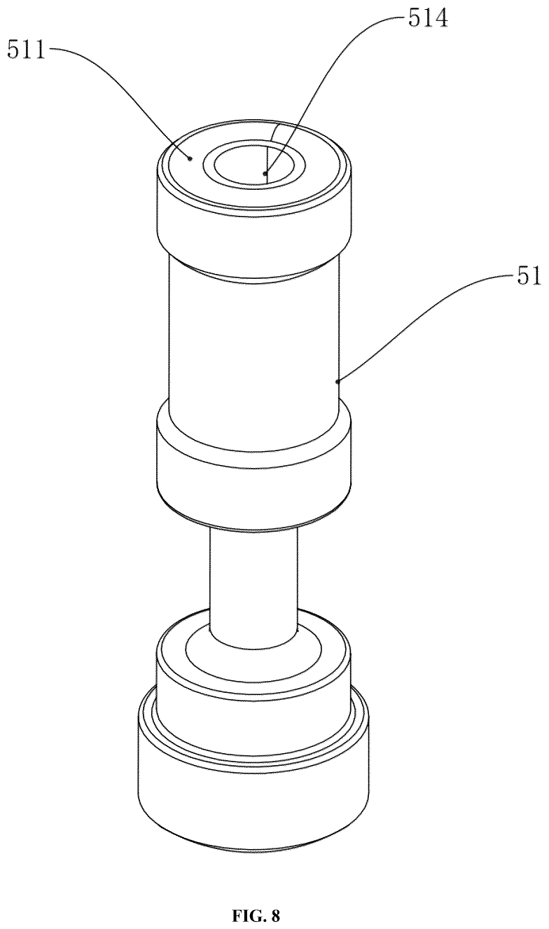

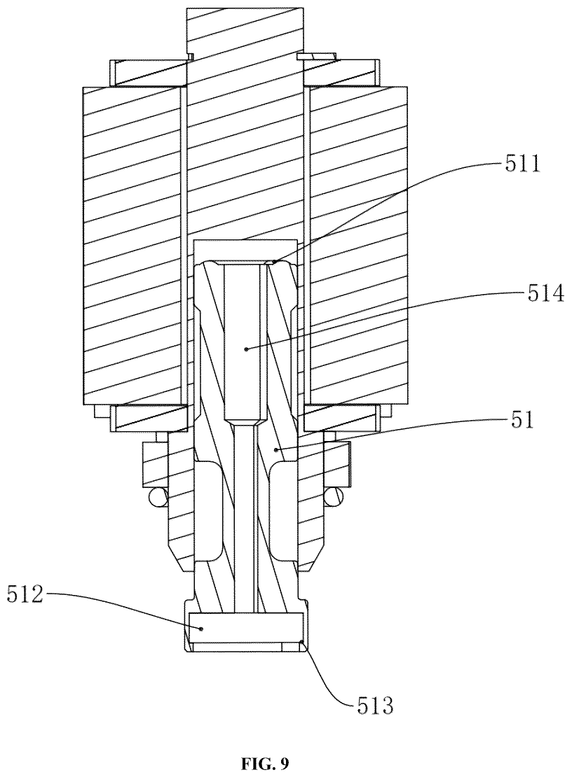

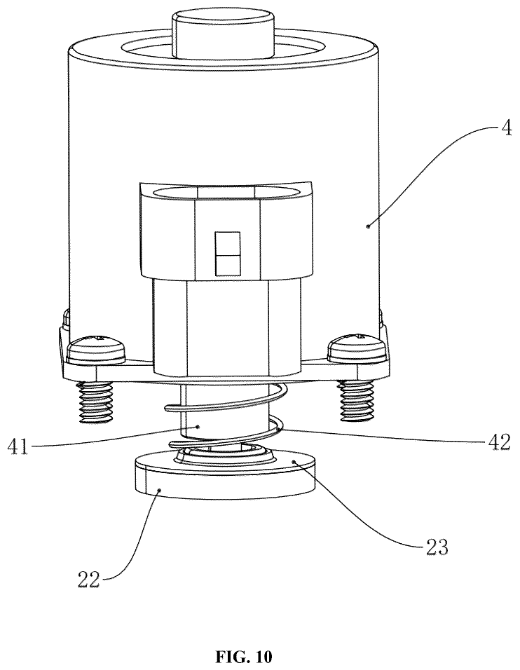

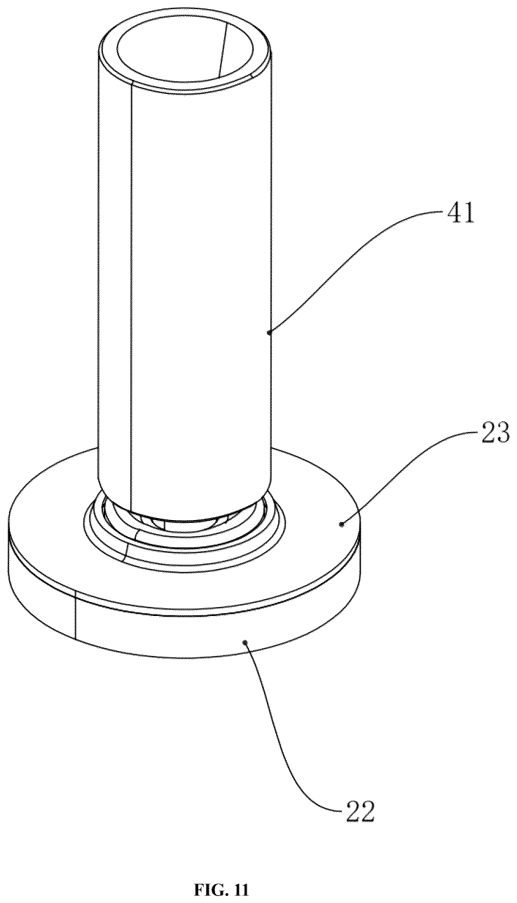

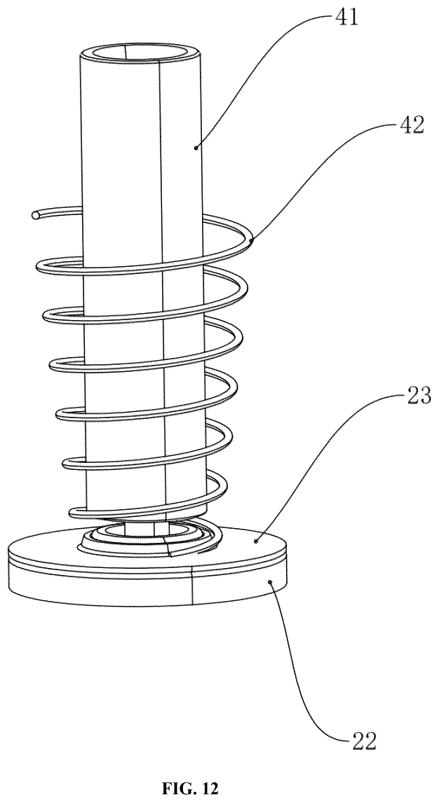

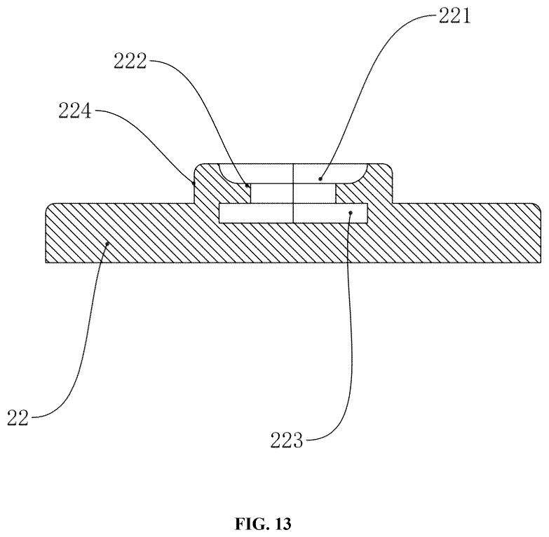

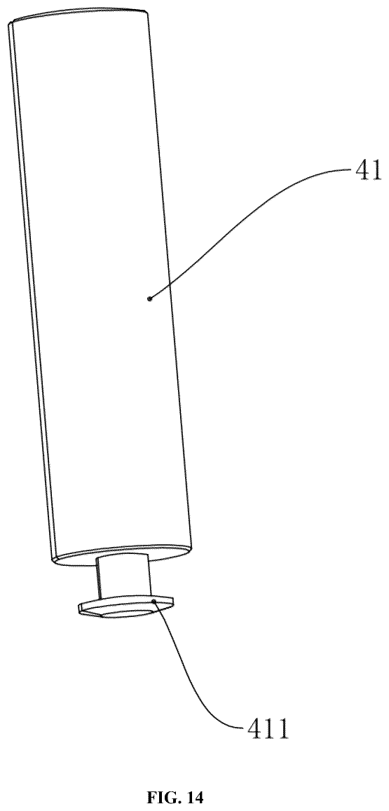

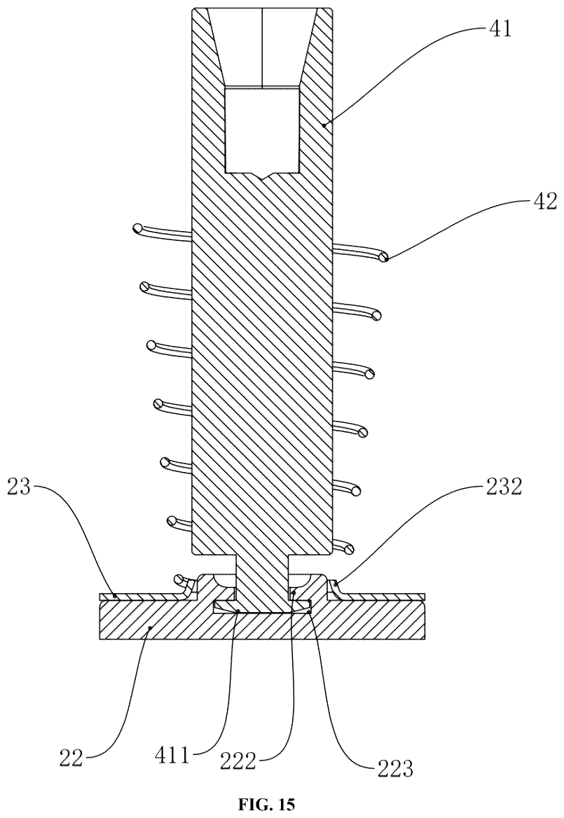

As shown in FIG. 1 to FIG. 15, an integrated, series-connected and electrically-controlled gas valve includes a valve body 1. A gas inlet runner, a gas outlet runner, and a first cavity 2 and a second cavity 3 which are arranged between the gas inlet runner and the gas outlet runner are arranged on the valve body 1. The first cavity 2 and the second cavity 3 are adjacent to each other. A first valve seat 21 and a first sealing gasket 22 cooperating with the first valve seat are arranged in the first cavity 2. A second valve seat 31 and a second sealing gasket 32 cooperating with the second valve seat 31 are arranged in the second cavity 3. The valve body 1 is provided with a first electromagnetic valve 4 at a position corresponding to the first cavity 2 and a second electromagnetic valve 5 at a position corresponding to the second cavity 3. The first electromagnetic valve 4 is provided with a first piston rod 41 connected to the first sealing gasket 22. The first sealing gasket 22 opens or closes the first valve seat 21 under action of the first piston rod 41. The first piston rod 41 is sleeved with a first reset spring 42, and the first reset spring 42 resists against the first sealing gasket 22, to drive the first sealing gasket 22 to move towards the first valve seat 21. The second electromagnetic valve 5 is provided with a second piston rod 51 connected to the second sealing gasket 32. The second sealing gasket 32 opens or closes the second valve seat 31 under action of the second piston rod 51. The second piston rod 51 is provided with a second reset spring 52 for driving the second piston rod 51 to move towards the second valve seat 31. A rubber ring 511 is arranged at another end portion of the second piston 51. Both the first electromagnetic valve 4 and the second electromagnetic valve 5 are arranged on the valve body 1 and are adjacent to each other, so that no other connection pipe is required for connection, thereby shortening a distance between the two electromagnetic valves. This ensures a stable pressure during gas conveying and accurate flow rate control. Meanwhile, the rubber ring 511 is arranged at the upper end portion of the second piston rod 51, so that an attraction force of the second piston rod 51 can be reduced when the second piston rod 51 attracts and opens the second valve seat 31, to prevent direct impact between the second piston rod 51 and a metal part on the second electromagnetic valve 5, thus implementing more precise control. The second piston rod 51 moves more steadily, and noises are reduced.

A mounting cavity 512 with an opened bottom is arranged at a lower end portion of the second piston rod 51. An annular boss 513 is arranged inside the mounting cavity 512. The second sealing gasket 32 is located inside the mounting cavity 512 and resists against the annular boss 513. When the second sealing gasket 32 resists against the second valve seat 31, the second valve seat 31 is closed, and an end portion of the second valve seat 31 is located inside the mounting cavity 512. Te second sealing gasket 32 has a firm structure and can be in better sealing fit with the second valve seat 31, so that the sealing performance is good when the second valve seat 31 is closed. An accommodating cavity 514 is arranged at an upper end portion of the second piston rod 51. The second reset spring 52 is arranged inside the accommodating cavity 514. The rubber ring 511 is integrally formed on the upper end surface of the second piston rod 51 and is located on an outer ring of the accommodating cavity 514. The second reset spring 52 has a stable structure, so that it better drives the second piston rod 51 to move towards the second valve seat 31.

The valve body 1 is provided with a passage 11 communicated with the first cavity 2, and a pressure sensor 6 is arranged at the passage 11. A pressure on the gas valve can be monitored in real time, and a flow rate can be calculated, to ensure that an engine can operate in an efficient, economical, and environmentally-friendly manner under various driving conditions.

A sealing rib 211 and inclined surfaces 212 located on two sides of the sealing rib 211 are arranged at an upper end of the first valve seat 21. A pressure plate 23 that moves synchronously with the first sealing gasket 22 is arranged on an upper end surface of the first sealing gasket 22. The first reset spring 42 resists against the pressure plate 23. The first sealing gasket 22 is in contact fit with the sealing rib 211 to close the first valve seat 21. The first sealing gasket 22 is separated from the sealing rib 211 to open the first valve seat 21. After power loss, the first reset spring 42 pushes the first sealing gasket 22 to move downwards to close the first valve seat 21, with high safety redundancy. The cooperation between the sealing rib 211 and the sealing gasket implements good sealing performance, and there are no air holes in the sealing rib 211 and the two inclined surfaces, which will not affect the sealing performance and can avoid a failure of opening the sealing gasket because of tar residues in gas. The pressure plate 23 presses the sealing gasket to ensure good sealing between the sealing gasket and the sealing rib 211 and avoid gas leakage from a gap reserved between the sealing gasket and the sealing rib 211.

An inverted “T”-shaped connection rod 411 is arranged at an end portion of the first piston rod 41. A sunken cavity 221 is formed in the first sealing gasket 22. An annular elastic sheet 222 is arranged on an inner side wall of the sunken cavity 221 in a circumferential direction of the inner side wall. The elastic sheet 222 and a bottom of the sunken cavity 221 are spaced apart to form a connection slot 223. A transverse portion of the connection rod 411 is located inside the connection slot 223. The elastic sheet 222 presses the transverse portion. A lower end surface of the transverse portion of the connection rod 411 is inclined. A first through hole cooperating with a vertical portion of the connection rod 411 is formed in a middle position of the elastic sheet 222. The vertical portion of the connection rod 411 is located inside the first through hole. It is convenient for connection between the first piston rod 41 and the first sealing gasket 22. The transverse portion is inserted from the first through hole, and the elastic sheet 222 can deform, so that the transverse portion enters the connection slot 223. The elastic sheet 222 presses the transverse portion to lock the transverse portion and prevent it from being detached. The arrangement of the inclined surfaces 212 facilitates sliding of the transverse portion and is easy for mounting. A positioning boss 224 is arranged at a middle position of the first sealing gasket 22. A second through hole and a positioning flange 232 that is located at a periphery of the second through hole and extends upwards are arranged at a middle position of the pressure plate 23. The positioning boos 224 is located inside the second through hole. An upper end surface of the positioning flange 232 is lower than an upper end surface of the positioning boss 224. The pressure plate 23 does not fully wrap around the first sealing gasket 22, making it easy to connect the first sealing gasket 22 to the first piston rod 41, but not affecting the effect of the pressure plate 23 on the first sealing gasket 22.

The integrated, series-connected and electrically-controlled gas valve further includes a silencer piece 7, and the silencer piece 7 is arranged at an upper end portion of the first piston rod 41. Noises are reduced, so that when the first piston rod 41 moves upwards to be opened under the action of the first electromagnetic valve, collision with the first piston rod 41 can be buffered, and a silencing effect can be achieved.

What is claimed is:

1. An integrated, series-connected and electrically-controlled gas valve, comprising a valve body (1), wherein a gas inlet runner, a gas outlet runner, and a first cavity (2) and a second cavity (3) which are arranged between the gas inlet runner and the gas outlet runner are arranged on the valve body (1); the first cavity (2) and the second cavity (3) are adjacent to each other; a first valve seat (21) and a first sealing gasket (22) cooperating with the first valve seat (21) are arranged in the first cavity (2); a second valve seat (31) and a second sealing gasket (32) cooperating with the second valve seat (31) are arranged in the second cavity (3); the valve body (1) is provided with a first electromagnetic valve (4) at a position corresponding to the first cavity (2) and a second electromagnetic valve (5) at a position corresponding to the second cavity (3); the first electromagnetic valve (4) is provided with a first piston rod (41) connected to the first sealing gasket (22); the first sealing gasket (22) opens or closes the first valve seat (21) under action of the first piston rod (41); the first piston rod (41) is sleeved with a first reset spring (42), and the first reset spring (42) resists against the first sealing gasket (22), to drive the first sealing gasket (22) to move towards the first valve seat (21); the second electromagnetic valve (5) is provided with a second piston rod (51) connected to the second sealing gasket (32); the second sealing gasket (32) opens or closes the second valve seat (31) under action of the second piston rod (51); the second piston rod (51) is provided with a second reset spring (52) for driving the second piston rod (51) to move towards the second valve seat (31); and a rubber ring (511) is arranged at another end portion of the second piston (51).

2. The integrated, series-connected and electrically-controlled gas valve according to claim 1, wherein a mounting cavity (512) with an opened bottom is arranged at a lower end portion of the second piston rod (51); an annular boss (513) is arranged inside the mounting cavity (512); the second sealing gasket (32) is located inside the mounting cavity (512) and resists against the annular boss (513); and when the second sealing gasket (32) resists against the second valve seat (31), the second valve seat (31) is closed, and an end portion of the second valve seat (31) is located inside the mounting cavity (512).

3. The integrated, series-connected and electrically-controlled gas valve according to claim 1, wherein an accommodating cavity (514) is arranged at an upper end portion of the second piston rod (51); the second reset spring (52) is arranged inside the accommodating cavity (514); and the rubber ring (511) is integrally formed on the upper end surface of the second piston rod (51) and is located on an outer ring of the accommodating cavity (514).

4. The integrated, series-connected and electrically-controlled gas valve according to claim 1, wherein the valve body (1) is provided with a passage (11) communicated with the first cavity (2), and a pressure sensor (6) is arranged at the passage (11).

5. The integrated, series-connected and electrically-controlled gas valve according to claim 1, wherein a sealing rib (211) and inclined surfaces (212) located on two sides of the sealing rib (211) are arranged at an upper end of the first valve seat (21); a pressure plate (23) that moves synchronously with the first sealing gasket (22) is arranged on an upper end surface of the first sealing gasket (22); the first reset spring (42) resists against the pressure plate (23); the first sealing gasket (22) is in contact fit with the sealing rib (211) to close the first valve seat (21); and the first sealing gasket (22) is separated from the sealing rib (211) to open the first valve seat (21).

6. The integrated, series-connected and electrically-controlled gas valve according to claim 5, wherein an inverted “T”-shaped connection rod (411) is arranged at an end portion of the first piston rod (41); a sunken cavity (221) is formed in the first sealing gasket (22); an annular elastic sheet (222) is arranged on an inner side wall of the sunken cavity (221) in a circumferential direction of the inner side wall; the elastic sheet (222) and a bottom of the sunken cavity (221) are spaced apart to form a connection slot (223); a transverse portion of the connection rod (411) is located inside the connection slot (223), and the elastic sheet (222) presses the transverse portion; a lower end surface of the transverse portion of the connection rod (411) is inclined; a first through hole cooperating with a vertical portion of the connection rod (411) is formed in a middle position of the elastic sheet (222); and the vertical portion of the connection rod (411) is located inside the first through hole.

7. The integrated, series-connected and electrically-controlled gas valve according to claim 5, wherein a positioning boss (224) is arranged at a middle position of the first sealing gasket (22); a second through hole (231) and a positioning flange (232) that is located at a periphery of the second through hole (231) and extends upwards are arranged at a middle position of the pressure plate (23); the positioning boos (224) is located inside the second through hole (231); and an upper end surface of the positioning flange (232) is lower than an upper end surface of the positioning boss (224).

8. The integrated, series-connected and electrically-controlled gas valve according to claim 5, further comprising a silencer piece (7), wherein the silencer piece (7) is arranged at an upper end portion of the first piston rod (41).
